(19) United States
(12) Patent Application Publication
(10) Pub. No.: US 2026/0278278 A1
(43) Pub. Date: Sep. 17, 2026

(54) SYSTEM FOR ANALYZING CALL DATA

(71) Applicant: SoftBank Group Corp., Tokyo (JP)

(72) Inventor: Takahiro KAMEMARU, Tokyo (JP)

(21) Appl. No.: 19/561,538

(22) Filed: Mar. 10, 2026

Related U.S. Application Data
(60) Provisional application No. 63/769,781, filed on Mar. 11, 2025.

(51) Int. Cl. G06F 40/30; G06F 40/279; G10L 15/26; G10L 21/0208; G10L 25/63

(52) U.S. Cl. CPC G06F 40/30; G06F 40/279; G10L 15/26; G10L 21/0208; G10L 2021/02082; G10L 25/63

(57) ABSTRACT

The present disclosure is a system that utilizes call data in a telephone service using SIP communication. A metadata collection unit collects metadata such as caller information and call duration of a call in real time, and a speech recognition unit converts speech data of the call into text. A natural language processing unit analyzes the content converted into text and performs keyword extraction and sentiment analysis. A data storage unit securely stores the analysis results, and a visual dashboard unit visualizes the results. An AI processing unit learns from past data and performs customer behavior prediction and suggestion to an operator.

### CROSS-REFERENCE TO RELATED APPLICATION

This application claims the benefit of priority from U.S. Provisional Patent Application No. 63/769,781, filed on Mar. 11, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is the effective utilization of call data in telephone services using SIP communication and the promotion of the transformation of such data into information assets associated therewith. Specifically, the disclosure aims to improve the current situation where call content is not fully utilized as an intangible information asset, and to maximize the utilization of call data as a valuable resource in business.

First, call data is usually treated as mere audio information and is often consumed as is once the call ends. For this reason, there is a problem that valuable information, customer needs, emotions, and the like contained in the call content are not fully utilized. This disclosure makes it possible to transcribe call data into text in real time and analyze it using natural language processing technology, thereby enabling detailed understanding of the call content and its use for business decision-making and service improvement.

In addition, there is also a problem that advanced technology is required for the analysis of call data, and there is a lack of a foundation for efficiently performing this. This disclosure enables companies to more effectively implement customer support and marketing strategies by utilizing AI technology to make predictions and suggestions based on call data.

Furthermore, privacy protection and legal compliance are important in the handling of call data. This disclosure aims to provide an environment where users can use the service with peace of mind by managing data in compliance with the applicable laws and regulations (Communications Act, Telecommunications Act, Electronic Communications Privacy Act, Children's Online Privacy Protection Act, Communications Decency Act, etc.). This makes it possible to utilize call data safely and effectively and to enhance the competitiveness of companies.

As a means for solving the problem, the present disclosure provides a system for processing call data using SIP communication. This system includes a metadata collection unit that collects metadata of a call, a speech recognition unit that converts speech data of the call into text in real time, a natural language processing unit that analyzes the call content converted into text, a data storage unit that stores analysis results in a database, a visual dashboard unit that visualizes the stored data, and an AI processing unit that performs prediction and suggestion based on the call data using AI technology.

The metadata collection unit collects metadata such as caller information, recipient information, call start time, and call identifier in real time, and manages this in a format compliant with the applicable laws and regulations (Telecommunications Business Act). The speech recognition unit performs preprocessing such as noise removal and speech clarification on the speech data of the call to achieve high-precision text conversion. The natural language processing unit performs processing including keyword extraction, sentiment analysis, and topic modeling to grasp the subject of the call, customer emotions, and topic trends.

The data storage unit securely stores the analysis results in a database and provides information to the user in an intuitive manner through the visual dashboard unit. The AI processing unit learns from past call data and predicts the customer's next action or suggests the optimal response method to the operator in real time. In this way, it becomes possible to maximize the utilization of call data as an intangible information asset and to enhance the business value of the company.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for analyzing call data.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

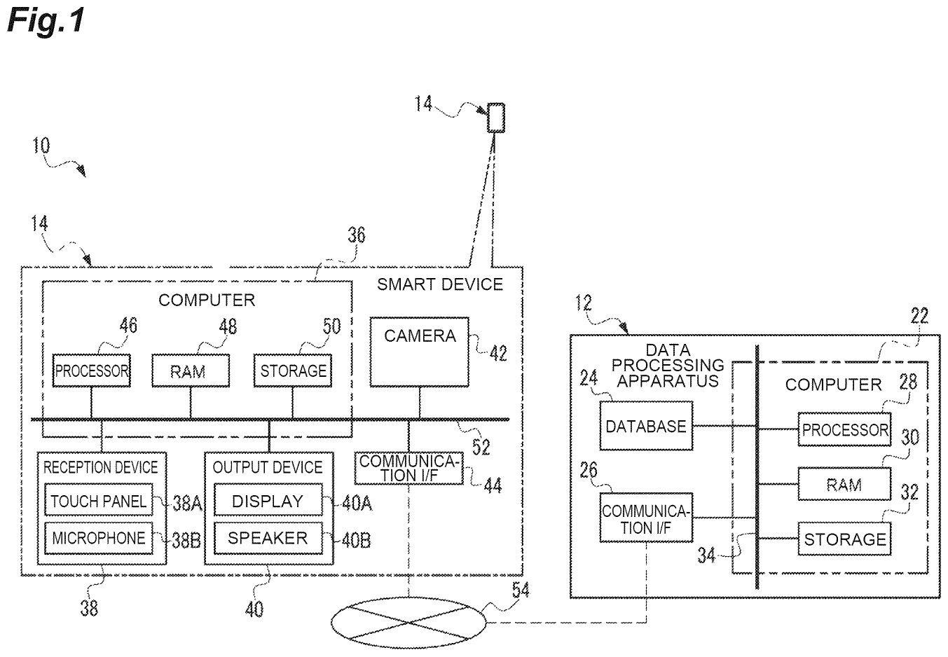

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

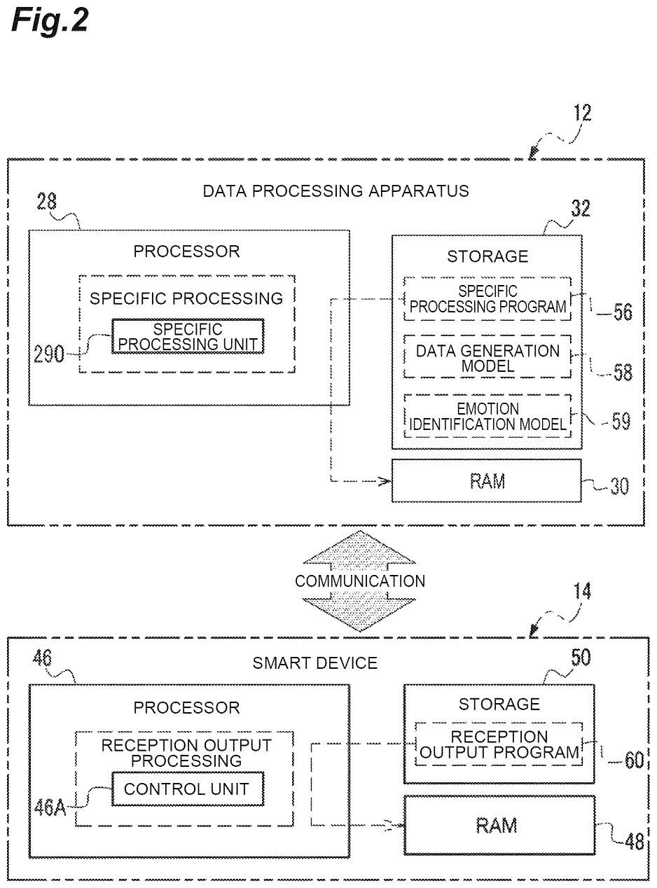

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

Details of a case where an embodiment is realized using a server and a terminal will be described more specifically.

First, a metadata collection unit that collects metadata of a call is realized on the server. The metadata collection unit may be configured by, for example, the specific processing unit 290, the specific processing program 56, the data generation model 58, and the emotion identification model 59. When a call is initiated via SIP communication, this unit collects metadata such as caller information, recipient information, call start time, call identifier, call end time, call duration, and geographical information of the call origin and destination in real time. For example, if a caller is calling from a specific region, metadata including that regional information can be collected and used for call analysis. In addition, the frequency of calls, the length of call times, and the success and failure rates of calls are also recorded as metadata, and this information plays an important role in subsequent analysis. Furthermore, tagging is also performed to identify the type of call (e.g., sales, support, customer service, etc.). The metadata collection unit stores the collected metadata in a format compliant with applicable laws and regulations, for example Communications Act, Telecommunications Act, Electronic Communications Privacy Act, Children's Online Privacy Protection Act, Communications Decency Act, etc.

The analysis processing of SIP (Session Initiation Protocol) communication by the metadata collection unit will be described in detail. The metadata collection unit may perform packet capture via a network interface card (NIC) and analyze request methods such as INVITE, BYE, and ACK included in the SIP header. Specifically, the terminal type is identified from the “User-Agent” field in the SIP header, and the uniqueness of the call session is ensured using the “Call-ID” field, while linking with the RTP (Real-time Transport Protocol) stream. This realizes accurate time-series synchronization even in a network environment where call content (payload) and control signals (header) arrive asynchronously, and guarantees context consistency in subsequent AI processing at the hardware level.

Next, a speech recognition unit that converts speech data of a call into text in real time is realized on both the server and the terminal. The speech recognition unit may be configured by, for example, the specific processing unit 290, the specific processing program 56, the data generation model 58, the emotion identification model 59, the processor 46, and the reception device 38. On the terminal side, speech data during a call is captured, and preprocessing such as noise removal and speech clarification is performed. For example, if there is a lot of background noise during a call, the speech data can be cleared using noise filtering technology. In addition, echo cancellation technology can be used to remove echoes during a call and improve speech clarity. On the server side, the preprocessed speech data is received and converted into text using a high-precision speech recognition engine. At this time, even if specific industry terms or technical terms are included, accurate text conversion is possible by using a customized dictionary. For example, if technical terms in the medical field or specific legal terms in the legal field are included, these terms can be accurately recognized and converted into text.

A natural language processing unit that analyzes the call content converted into text is realized on the server. The natural language processing unit may be configured by, for example, the specific processing unit 290, the specific processing program 56, the data generation model 58, and the emotion identification model 59. This unit performs processing such as keyword extraction, sentiment analysis, topic modeling, context analysis, and intent recognition. For example, it is possible to extract customer complaints from the call content and evaluate customer satisfaction through sentiment analysis. Furthermore, by using context analysis, it is possible to understand the background and situation in which the customer is speaking and obtain deeper insights. In addition, topic modeling can be used to grasp what topics the call is focused on and to help formulate marketing strategies. For example, if inquiries about a specific product are increasing, this data can be utilized as data for developing a campaign related to that product.

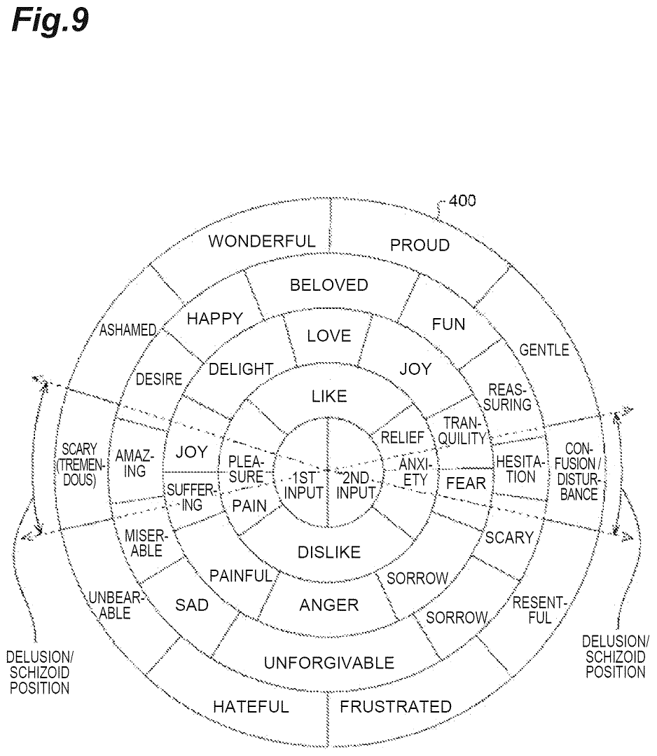

The natural language processing unit and the AI processing unit described later may be specifically configured by a neural network using a Transformer architecture (for example, a BERT or GPT-based model). Data converted into text by the speech recognition unit is vectorized (Embedding) by a tokenizer and mapped onto a multidimensional vector space. Here, the emotion identification model 59 identifies an emotion by calculating the cosine similarity between the input text vector and a reference vector corresponding to each emotion on the emotion map 400 shown in FIG. 9. This processing is executed by parallel computation on a GPU (Graphics Processing Unit) or TPU (Tensor Processing Unit), and quantization or pruning of inference processing is performed so that the latency (delay) of the call does not exceed a predetermined threshold (for example, 200 ms).

A data storage unit that stores the analysis results in a database is also realized on the server. The data storage unit may be configured by, for example, the specific processing unit 290, the specific processing program 56, and the storage 32. This unit securely stores the analysis results and makes them quickly accessible when needed. For example, by referring to past call data, it becomes possible to check the customer's history and provide more personalized services. The database is protected using encryption technology as a security measure, and unauthorized access to data is prevented by strictly controlling access. In addition, data backups are performed regularly to ensure redundancy to prevent data loss.

A visual dashboard unit that visualizes the stored data is realized on the server and is accessible from the terminal. The visual dashboard unit may be configured by, for example, the specific processing unit 290, the specific processing program 56, the data generation model 58, and the emotion identification model 59. This unit visually displays the analysis results as graphs and charts, allowing users to intuitively understand the information. For example, by displaying the trend of call content in chronological order, it is possible to grasp at a glance what topics were frequent during which period. In addition, by displaying the customer's sentiment analysis results as a heat map, it is possible to visually confirm which customers are satisfied and which customers are dissatisfied. Furthermore, the dashboard is customizable, and users can select the information to be displayed according to their needs.

Finally, an AI processing unit that performs prediction and suggestion based on call data using AI technology is realized on the server. The AI processing unit may be configured by, for example, the specific processing unit 290, the specific processing program 56, the data generation model 58, and the emotion identification model 59. This unit learns from past call data and predicts the customer's next action or suggests the optimal response method to the operator in real time. For example, if a customer is showing interest in a specific product, information related to that product can be provided to the operator to support effective closing. In addition, the AI is equipped with an anomaly detection function, which detects unusual call patterns and contributes to security improvement. For example, it can automatically identify potentially fraudulent calls and issue a warning to the operator.

The suggestion and control by the AI processing unit are not limited to mere display of information. For example, when the AI processing unit determines from the call data that the emotion value of “customer anger (Anger)” exceeds a predetermined threshold, the system automatically transmits a REFER method to the SIP server and issues a control signal to transfer the call to the terminal of a skilled operator or supervisor. In addition, when a pattern with a high possibility of fraud (frequent occurrence of specific keywords or abnormality in voice stress value) is detected, the system maintains the call session while mirroring and transmitting location information and voice data in real time to the server of a law enforcement agency via an end-to-end encrypted (E2EE) communication path. Thereby, immediate risk avoidance actions at the network level are executed without human intervention.

In this way, the present disclosure makes it possible to maximize the utilization of call data as an intangible information asset and to enhance the business value of a company through a system that combines a server and a terminal.

### (System Configuration)

The system according to the present embodiment includes a metadata collection unit, a speech recognition unit, a natural language processing unit, a data storage unit, a visual dashboard unit, and an AI processing unit.

When a call is initiated via SIP communication, the metadata collection unit collects metadata such as caller information, recipient information, call start time, call identifier, call end time, call duration, and geographical information of the call origin and destination in real time. This unit can, for example, collect metadata including regional information if a caller is calling from a specific region, and use it for call analysis. In addition, the frequency of calls, the length of call times, and the success and failure rates of calls are also recorded as metadata, and this information plays an important role in subsequent analysis. Furthermore, tagging is also performed to identify the type of call (e.g., sales, support, customer service, etc.). This enables analysis according to the content and purpose of the call, and realizes more accurate data utilization.

The speech recognition unit is responsible for converting the speech data of a call into text in real time. This unit captures the speech data during the call on the terminal side and performs preprocessing such as noise removal and speech clarification. For example, if there is a lot of background noise during a call, the speech data can be cleared using noise filtering technology. In addition, echo cancellation technology can be used to remove echoes during a call and improve speech clarity. On the server side, the preprocessed speech data is received and converted into text using a high-precision speech recognition engine. At this time, even if specific industry terms or technical terms are included, accurate text conversion is possible by using a customized dictionary. For example, if technical terms in the medical field or specific legal terms in the legal field are included, these terms can be accurately recognized and converted into text.

The natural language processing unit analyzes the call content converted into text. This unit performs processing such as keyword extraction, sentiment analysis, topic modeling, context analysis, and intent recognition. For example, it is possible to extract customer complaints from the call content and evaluate customer satisfaction through sentiment analysis. Furthermore, by using context analysis, it is possible to understand the background and situation in which the customer is speaking and obtain deeper insights. In addition, topic modeling can be used to grasp what topics the call is focused on and to help formulate marketing strategies. For example, if inquiries about a specific product are increasing, this data can be utilized as data for developing a campaign related to that product.

The data storage unit securely stores the analysis results in a database. This unit makes the analysis results quickly accessible, and by referring to past call data, it becomes possible to check the customer's history and provide more personalized services. The database is protected using encryption technology as a security measure, and unauthorized access to data is prevented by strictly controlling access. In addition, data backups are performed regularly to ensure redundancy to prevent data loss. For example, by referring to a customer's past inquiry history, it can be utilized as information for responding quickly when a similar problem reoccurs.

The visual dashboard unit visualizes the stored data. This unit visually displays the analysis results as graphs and charts, allowing users to intuitively understand the information. For example, by displaying the trend of call content in chronological order, it is possible to grasp at a glance what topics were frequent during which period. In addition, by displaying the customer's sentiment analysis results as a heat map, it is possible to visually confirm which customers are satisfied and which customers are dissatisfied. Furthermore, the dashboard is customizable, and users can select the information to be displayed according to their needs. For example, by displaying data narrowed down to a specific region or period, it is possible to analyze trends for each region.

The AI processing unit performs prediction and suggestion based on call data using AI technology. This unit learns from past call data and predicts the customer's next action or suggests the optimal response method to the operator in real time. For example, if a customer is showing interest in a specific product, information related to that product can be provided to the operator to support effective closing. In addition, the AI is equipped with an anomaly detection function, which detects unusual call patterns and contributes to security improvement. For example, it can automatically identify potentially fraudulent calls and issue a warning to the operator. Furthermore, the AI analyzes the customer's past behavior patterns and predicts future needs, thereby enabling proactive service provision.

Specific examples of prompt sentences to be read into the generative AI necessary for carrying out the present disclosure include “Please tell me how to convert call data into text in real time and analyze customer emotions” and “Please show me the procedure for building an AI model to predict a customer's next action using past call data”. By using these prompt sentences, the generative AI can provide details of specific processing methods and algorithms in each unit of the present disclosure.

### (Implementation Steps)

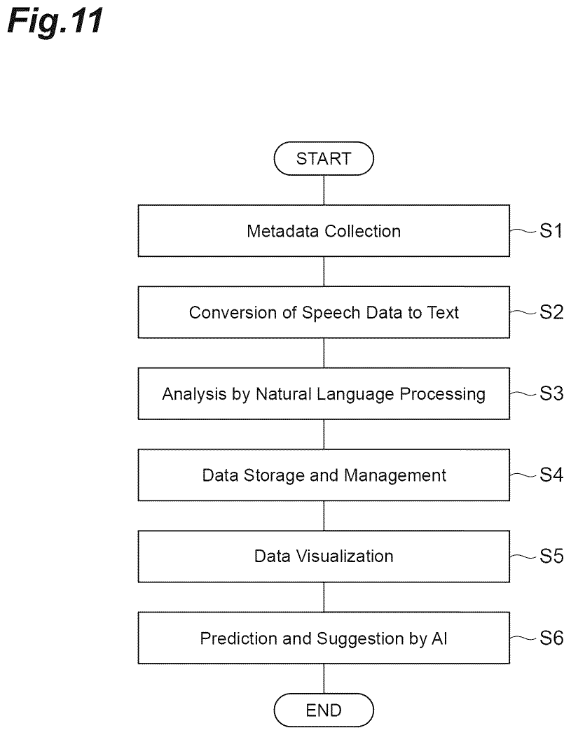

### Step 1: Metadata Collection (See Step S2 in FIG. 11)

When a call is initiated via SIP communication, the metadata collection unit collects metadata such as caller information, recipient information, call start time, call identifier, call end time, call duration, and geographical information of the call origin and destination in real time. For example, if a caller is calling from a specific region, metadata including that regional information can be collected and used for call analysis. In addition, the frequency of calls, the length of call times, and the success and failure rates of calls are also recorded as metadata, and this information plays an important role in subsequent analysis. Furthermore, tagging is also performed to identify the type of call (sales, support, customer service, etc.).

### Step 2: Conversion of Speech Data to Text (See Step S2 in FIG. 11)

The speech recognition unit converts the speech data of the call into text in real time. On the terminal side, the speech data during the call is captured, and preprocessing such as noise removal and speech clarification is performed. For example, if there is a lot of background noise during a call, the speech data can be cleared using noise filtering technology. On the server side, the preprocessed speech data is received and converted into text using a high-precision speech recognition engine. At this time, even if specific industry terms or technical terms are included, accurate text conversion is possible by using a customized dictionary.

### Step 3: Analysis by Natural Language Processing (See Step S3 in FIG. 11)

The natural language processing unit analyzes the call content converted into text. It performs processing such as keyword extraction, sentiment analysis, topic modeling, context analysis, and intent recognition. For example, it is possible to extract customer complaints from the call content and evaluate customer satisfaction through sentiment analysis. Furthermore, by using context analysis, it is possible to understand the background and situation in which the customer is speaking and obtain deeper insights. Topic modeling can be used to grasp what topics the call is focused on and to help formulate marketing strategies.

### Step 4: Data Storage and Management (See Step S4 in FIG. 11)

The data storage unit securely stores the analysis results in a database. It makes the analysis results quickly accessible, and by referring to past call data, it becomes possible to check the customer's history and provide more personalized services. The database is protected using encryption technology as a security measure, and unauthorized access to data is prevented by strictly controlling access. In addition, data backups are performed regularly to ensure redundancy to prevent data loss.

### Step 5: Data Visualization (See Step S5 in FIG. 11)

The visual dashboard unit visualizes the stored data. It visually displays the analysis results as graphs and charts, allowing users to intuitively understand the information. For example, by displaying the trend of call content in chronological order, it is possible to grasp at a glance what topics were frequent during which period. The customer's sentiment analysis results can be displayed as a heat map to visually confirm which customers are satisfied and which customers are dissatisfied.

### Step 6: Prediction and Suggestion by AI (See Step S6 in FIG. 11)

The AI processing unit performs prediction and suggestion based on call data using AI technology. It learns from past call data and predicts the customer's next action or suggests the optimal response method to the operator in real time. For example, if a customer is showing interest in a specific product, information related to that product can be provided to the operator to support effective closing. Specific examples of prompt sentences to be read into the generative AI include “Please tell me how to convert call data into text in real time and analyze customer emotions” and “Please show me the procedure for building an AI model to predict a customer's next action using past call data”.

### (Specific Use Case)

For example, in a customer support center, by using the system of the present disclosure, customer support that highly utilizes call data becomes possible. When a customer calls the support center, a call is initiated via SIP communication, and the metadata collection unit collects metadata such as caller information, recipient information, call start time, and call duration in real time. This allows the customer's basic information and call history to be immediately grasped, enabling the operator to provide a prompt and accurate response.

The speech recognition unit converts the speech data during the call into text in real time and performs noise removal and speech clarification. This allows the customer's utterances to be accurately converted into text and used for subsequent analysis. In particular, even when technical terms or industry-specific words are included, misrecognition is prevented and accurate text conversion is realized by using a customized dictionary.

The natural language processing unit analyzes the call content converted into text and performs keyword extraction and sentiment analysis. This makes it possible to grasp the customer's main inquiry content and emotional state. For example, if a customer is expressing dissatisfaction about a product defect, that point of dissatisfaction can be quickly extracted and notified to the operator, making it possible to take appropriate countermeasures. In addition, topic modeling can be used to grasp what topics the call content is focused on and to help improve products and services.

The data storage unit securely stores the analysis results in a database, and by referring to past call data, it becomes possible to check the customer's history and provide more personalized services. For example, for a customer who has made a similar inquiry in the past, a solution can be promptly presented, contributing to an improvement in customer satisfaction.

The visual dashboard unit visually displays the analysis results as graphs and charts, allowing users to intuitively understand the information. For example, by displaying the customer's sentiment analysis results as a heat map, it is possible to visually confirm which customers are satisfied and which customers are dissatisfied. This allows the operator to grasp the customer's emotional state and provide a more appropriate response.

The AI processing unit performs prediction and suggestion based on call data using AI technology. It learns from past call data and predicts the customer's next action or suggests the optimal response method to the operator in real time. For example, if a customer is showing interest in a specific product, information related to that product can be provided to the operator to support effective closing. Specific examples of prompt sentences to be read into the generative AI include “Please tell me how to convert call data into text in real time and analyze customer emotions” and “Please show me the procedure for building an AI model to predict a customer's next action using past call data”. This allows the generative AI to provide details of specific processing methods and algorithms in each unit of the present disclosure.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described in further detail, specifically a communication analysis system in a nursing care facility. This system aims to improve the quality of care by analyzing conversations within the nursing care facility in real time to grasp the emotional and health states of residents.

First, a metadata collection unit collects metadata such as participant information of conversations held in a nursing care facility, start times of conversations, durations of conversations, and locations of conversations in real time. This unit can, for example, grasp how often a specific resident is conversing with which staff member. This makes it possible to evaluate the resident's social interaction status and to take measures to prevent isolation. In addition, by using the conversation location information, it is possible to analyze in which areas conversations are frequently held and to help optimize the flow and arrangement within the facility. Furthermore, tagging is also performed to identify the type of conversation (e.g., daily conversation, health consultation, emergency response, etc.), which enables analysis according to the purpose of the conversation.

Next, a speech recognition unit converts the speech data of the conversation into text in real time. This unit performs noise removal and speech clarification to realize accurate text conversion. For example, although there may be a lot of background noise in a nursing care facility, the speech data can be cleared using noise filtering technology. In addition, echo cancellation technology can be used to remove echoes during a call and improve speech clarity. Furthermore, even when technical terms used in the nursing care field or words related to specific care are included, misrecognition is prevented and accurate text conversion is possible by using a customized dictionary. For example, if medical terms or nursing care terms are frequently used, accurately recognizing and converting them into text can be useful for subsequent analysis.

The natural language processing unit analyzes the conversation content converted into text. This unit performs processing such as keyword extraction, sentiment analysis, topic modeling, context analysis, and intent recognition. For example, it is possible to extract a resident's anxiety or dissatisfaction from the conversation content and evaluate the resident's satisfaction level through sentiment analysis. Furthermore, by using context analysis, it is possible to understand the background and situation in which the resident is speaking and obtain deeper insights. In addition, topic modeling can be used to grasp what topics the conversation is focused on and to help formulate care plans. For example, if conversations about a specific health problem are increasing, that information can be used to contact medical staff and enable a prompt response. Furthermore, by using intent recognition, it is possible to accurately grasp what a resident is requesting and provide appropriate services.

The data storage unit securely stores the analysis results in a database. This unit makes the analysis results quickly accessible, and by referring to past conversation data, it becomes possible to check the resident's history and provide more personalized services. The database is protected using encryption technology as a security measure, and unauthorized access to data is prevented by strictly controlling access. In addition, data backups are performed regularly to ensure redundancy to prevent data loss. For example, by referring to a resident's past health and emotional states, it can be utilized as information for responding quickly when a similar problem reoccurs.

For privacy protection in nursing care facilities and the like, the data storage unit has a function of automatically detecting and masking personally identifiable information (PII: name, address, telephone number, etc.) contained in voice data and text data. Specifically, PII is identified using a Named Entity Recognition (NER) algorithm, and the relevant part is replaced with an irreversible hash value or a random character string before being stored in the database 24. Furthermore, access to the stored data is recorded in a tamper-proof state using blockchain technology or distributed ledger technology, and managed in a state where who accessed which data and when can be mathematically proven.

The AI processing unit performs prediction and suggestion based on conversation data using AI technology. This unit learns from past conversation data and predicts changes in the resident's behavior and health state. This allows care staff to proactively provide care and improve the resident's quality of life. For example, if a resident has a specific health problem, its signs can be detected early and medical staff can be contacted, enabling a prompt response. In addition, by analyzing the resident's behavior patterns and predicting risks in daily life, accidents and injuries can be prevented. Furthermore, the AI continuously monitors the resident's emotional state and contributes to maintaining mental health by discovering signs of stress and anxiety early.

In this way, the present disclosure becomes a powerful tool for improving the quality of communication in nursing care facilities and protecting the health and safety of residents. Specific examples of prompt sentences to be read into the generative AI include “Please tell me how to convert conversation data in a nursing care facility into text in real time and analyze the residents' emotions” and “Please show me the procedure for building an AI model to predict a resident's health state using past conversation data”. This allows the generative AI to provide details of specific processing methods and algorithms in each unit of the present disclosure.

### (System Configuration)

The system according to the present embodiment includes a metadata collection unit, a speech recognition unit, a natural language processing unit, a data storage unit, and an AI processing unit.

The metadata collection unit collects metadata such as participant information of conversations held in a nursing care facility, start times of conversations, durations of conversations, and locations of conversations in real time. This unit can, for example, grasp how often a specific resident is conversing with which staff member. This makes it possible to evaluate the resident's social interaction status and to take measures to prevent isolation. In addition, by using the conversation location information, it is possible to analyze in which areas conversations are frequently held and to help optimize the flow and arrangement within the facility. Furthermore, tagging is also performed to identify the type of conversation, which enables analysis according to the purpose of the conversation. For example, by assigning tags such as daily conversation, health consultation, and emergency response, the content of the conversation can be classified in more detail, and the accuracy of the analysis can be improved.

The speech recognition unit converts the speech data of the conversation into text in real time. This unit performs noise removal and speech clarification to realize accurate text conversion. For example, although there may be a lot of background noise in a nursing care facility, the speech data can be cleared using noise filtering technology. In addition, echo cancellation technology can be used to remove echoes during a call and improve speech clarity. Furthermore, even when technical terms used in the nursing care field or words related to specific care are included, misrecognition is prevented and accurate text conversion is possible by using a customized dictionary. For example, if medical terms or nursing care terms are frequently used, accurately recognizing and converting them into text can be useful for subsequent analysis.

The natural language processing unit analyzes the conversation content converted into text. This unit performs processing such as keyword extraction, sentiment analysis, topic modeling, context analysis, and intent recognition. For example, it is possible to extract a resident's anxiety or dissatisfaction from the conversation content and evaluate the resident's satisfaction level through sentiment analysis. Furthermore, by using context analysis, it is possible to understand the background and situation in which the resident is speaking and obtain deeper insights. In addition, topic modeling can be used to grasp what topics the conversation is focused on and to help formulate care plans. For example, if conversations about a specific health problem are increasing, that information can be used to contact medical staff and enable a prompt response. Furthermore, by using intent recognition, it is possible to accurately grasp what a resident is requesting and provide appropriate services.

The data storage unit securely stores the analysis results in a database. This unit makes the analysis results quickly accessible, and by referring to past conversation data, it becomes possible to check the resident's history and provide more personalized services. The database is protected using encryption technology as a security measure, and unauthorized access to data is prevented by strictly controlling access. In addition, data backups are performed regularly to ensure redundancy to prevent data loss. For example, by referring to a resident's past health and emotional states, it can be utilized as information for responding quickly when a similar problem reoccurs.

The AI processing unit performs prediction and suggestion based on conversation data using AI technology. This unit learns from past conversation data and predicts changes in the resident's behavior and health state. This allows care staff to proactively provide care and improve the resident's quality of life. For example, if a resident has a specific health problem, its signs can be detected early and medical staff can be contacted, enabling a prompt response. In addition, by analyzing the resident's behavior patterns and predicting risks in daily life, accidents and injuries can be prevented. Furthermore, the AI continuously monitors the resident's emotional state and contributes to maintaining mental health by discovering signs of stress and anxiety early.

In this way, the present disclosure becomes a powerful tool for improving the quality of communication in nursing care facilities and protecting the health and safety of residents. Specific examples of prompt sentences to be read into the generative AI include “Please tell me how to convert conversation data in a nursing care facility into text in real time and analyze the residents' emotions” and “Please show me the procedure for building an AI model to predict a resident's health state using past conversation data”. This allows the generative AI to provide details of specific processing methods and algorithms in each unit of the present disclosure.

### (Implementation Steps)

### Step 1: Metadata Collection

The metadata collection unit collects metadata such as participant information of conversations held in a nursing care facility, start times of conversations, durations of conversations, and locations of conversations in real time. In this step, for example, it is possible to grasp how often a specific resident is conversing with which staff member. This makes it possible to evaluate the resident's social interaction status and to take measures to prevent isolation. In addition, by using the conversation location information, it is possible to analyze in which areas conversations are frequently held and to help optimize the flow and arrangement within the facility. Furthermore, tagging is also performed to identify the type of conversation, which enables analysis according to the purpose of the conversation.

### Step 2: Conversion of Speech Data to Text

The speech recognition unit converts the speech data of the conversation into text in real time. In this step, noise removal and speech clarification are performed to realize accurate text conversion. For example, although there may be a lot of background noise in a nursing care facility, the speech data can be cleared using noise filtering technology. In addition, echo cancellation technology can be used to remove echoes during a call and improve speech clarity. Furthermore, even when technical terms used in the nursing care field or words related to specific care are included, misrecognition is prevented and accurate text conversion is possible by using a customized dictionary.

### Step 3: Analysis by Natural Language Processing

The natural language processing unit analyzes the conversation content converted into text. In this step, processing such as keyword extraction, sentiment analysis, topic modeling, context analysis, and intent recognition is performed. For example, it is possible to extract a resident's anxiety or dissatisfaction from the conversation content and evaluate the resident's satisfaction level through sentiment analysis. Furthermore, by using context analysis, it is possible to understand the background and situation in which the resident is speaking and obtain deeper insights. In addition, topic modeling can be used to grasp what topics the conversation is focused on and to help formulate care plans.

### Step 4: Data Storage and Management

The data storage unit securely stores the analysis results in a database. In this step, the analysis results are made quickly accessible, and by referring to past conversation data, it becomes possible to check the resident's history and provide more personalized services. The database is protected using encryption technology as a security measure, and unauthorized access to data is prevented by strictly controlling access. In addition, data backups are performed regularly to ensure redundancy to prevent data loss.

### Step 5: Prediction and Suggestion by AI

The AI processing unit performs prediction and suggestion based on conversation data using AI technology. In this step, past conversation data is learned to predict changes in the resident's behavior and health state. This allows care staff to proactively provide care and improve the resident's quality of life. For example, if a resident has a specific health problem, its signs can be detected early and medical staff can be contacted, enabling a prompt response. In addition, by analyzing the resident's behavior patterns and predicting risks in daily life, accidents and injuries can be prevented. Specific examples of prompt sentences to be read into the generative AI include “Please tell me how to convert conversation data in a nursing care facility into text in real time and analyze the residents' emotions” and “Please show me the procedure for building an AI model to predict a resident's health state using past conversation data”.

### (Specific Use Case)

For example, in a nursing care facility, by using the system of the present disclosure, it is possible to monitor the health and emotional state of residents. This system analyzes conversations held between care staff and residents in real time and provides information for providing care tailored to the residents' needs.

The metadata collection unit collects metadata such as participant information of conversations between residents and care staff, conversation start times, durations, and conversation locations. This makes it possible to grasp which staff member is conversing with which resident and at what frequency. For example, if a specific resident is frequently conversing with a specific staff member, it is possible to evaluate the resident's social interaction status based on that relationship and to take measures to prevent isolation.

The speech recognition unit converts the speech data of the conversation into text in real time and performs noise removal and speech clarification. For example, even in an environment with a lot of background noise within the facility, the speech data is cleared using noise filtering technology to realize accurate text conversion. Furthermore, even when technical terms used in the nursing care field or words related to specific care are included, misrecognition is prevented by using a customized dictionary.

The natural language processing unit analyzes the conversation content converted into text and performs keyword extraction and sentiment analysis. For example, if a resident is expressing anxiety about their health, that anxiety can be quickly extracted and notified to the care staff, thereby prompting an appropriate response. In addition, topic modeling can be used to grasp what topics the conversation is focused on and to help formulate care plans.

The AI processing unit learns from past conversation data and predicts changes in the resident's behavior and health state. For example, if a resident has a specific health problem, its signs can be detected early and medical staff can be contacted, enabling a prompt response. In addition, by analyzing the resident's behavior patterns and predicting risks in daily life, accidents and injuries can be prevented.

Specific examples of prompt sentences to be read into the generative AI include “Please tell me how to convert conversation data in a nursing care facility into text in real time and analyze the residents' emotions” and “Please show me the procedure for building an AI model to predict a resident's health state using past conversation data”. This allows the generative AI to provide details of specific processing methods and algorithms in each unit of the present disclosure.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

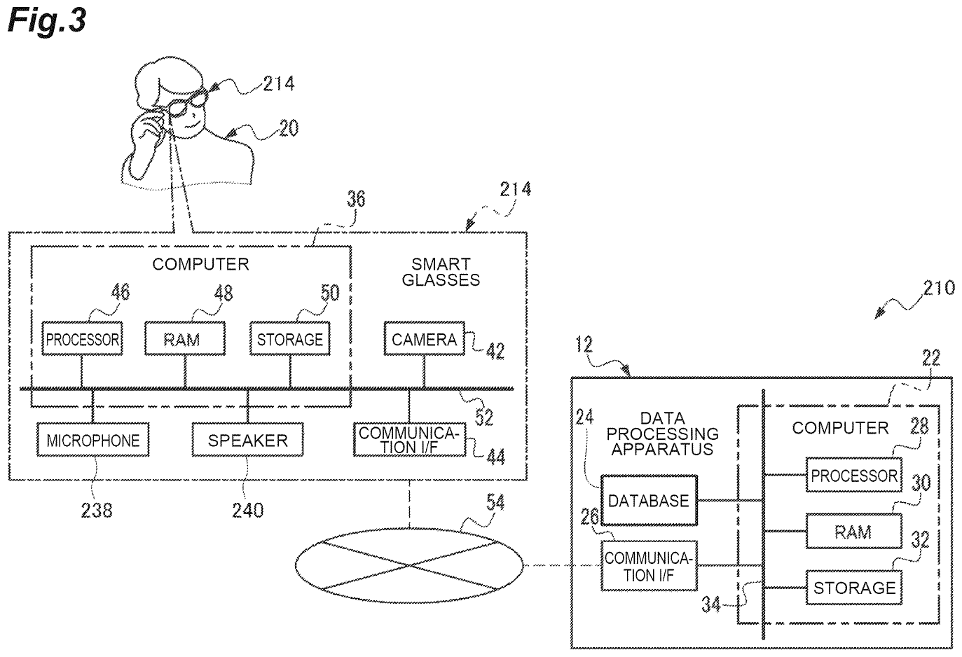

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

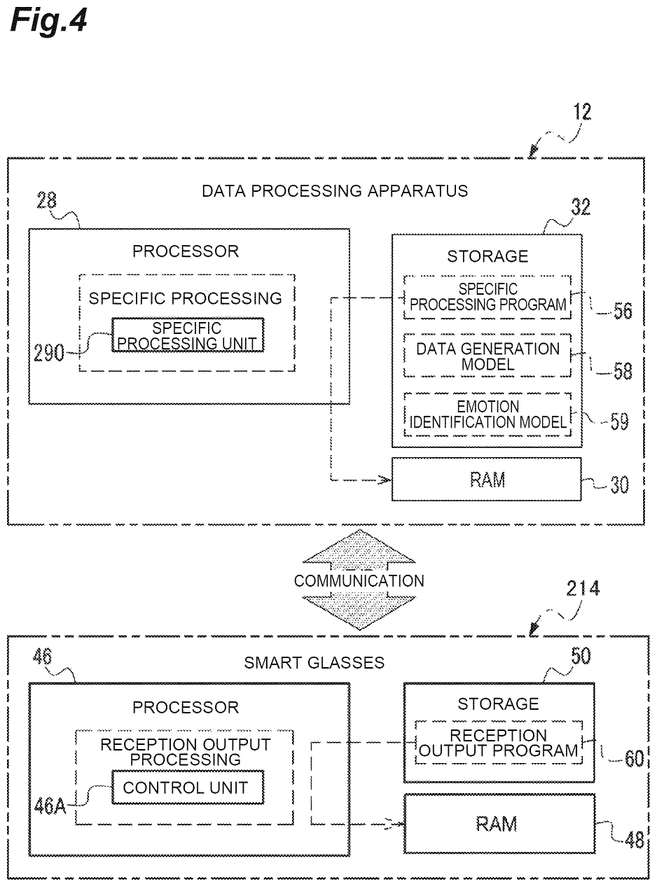

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

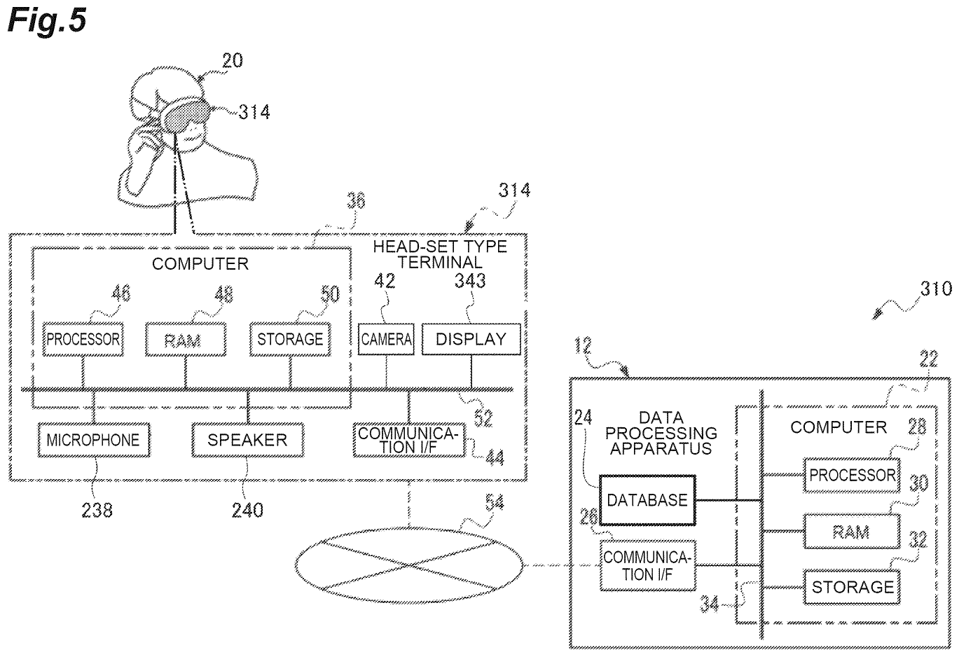

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

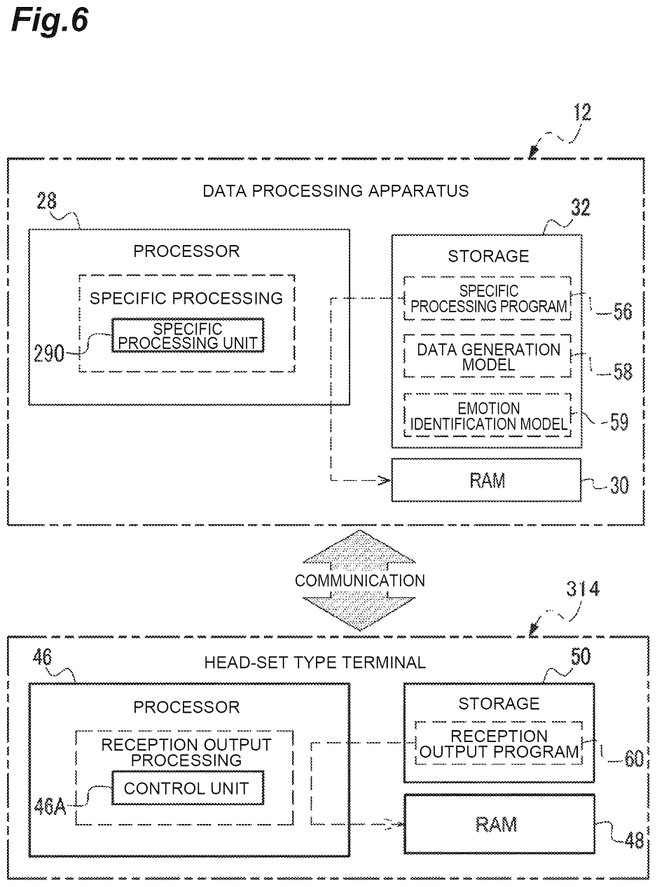

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

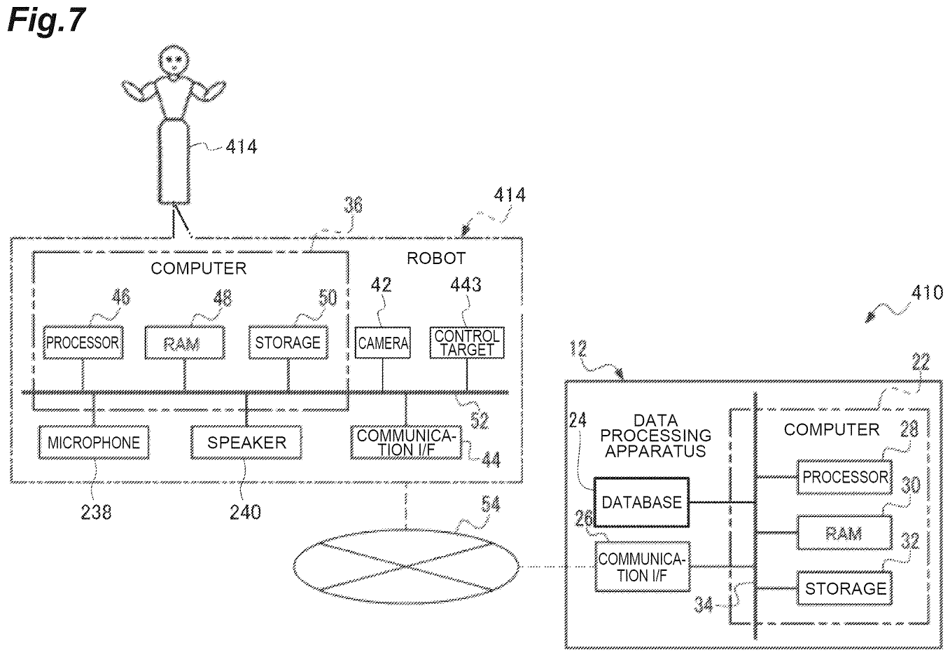

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

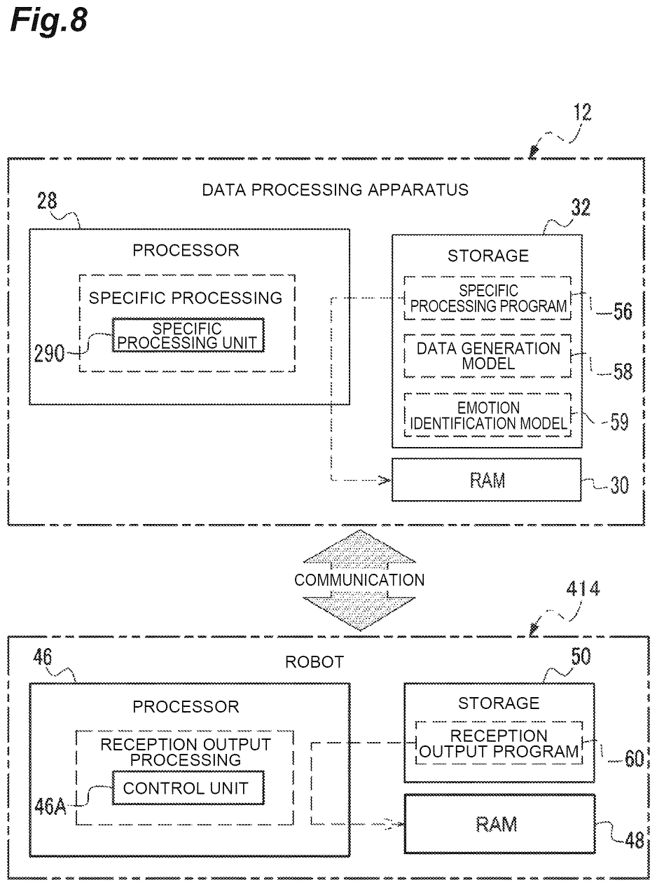

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

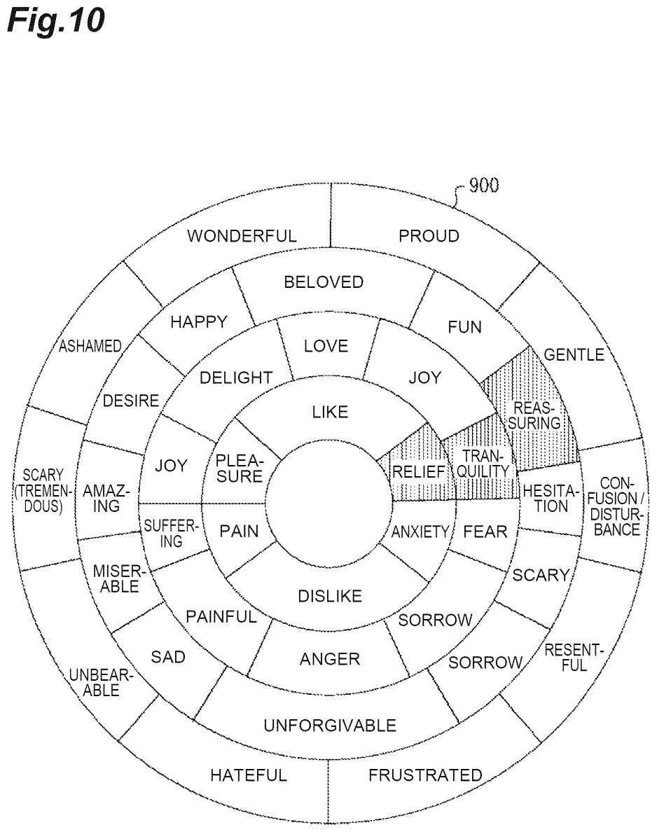

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

The emotion value identified by the emotion identification model 59 is directly converted into physical actuator control parameters of the robot 414. For example, when mapped to the “anger” region in the emotion map 400, the processor 46 adjusts the PID control gain of each joint motor of the robot, suppresses the acceleration of the motion, and generates a “slow motion that does not give a sense of intimidation”. Conversely, in the case of the “joy” region, control is performed to increase the luminance modulation frequency of the LED and widen the range of motion of the motor. In this way, the present system functions as a converter that converts abstract information called “emotion” into specific control signals (voltage, current, PWM signal) in robotics, and improves the safety of physical interaction between humans and robots.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A communication analysis system in a nursing care facility, comprising a metadata collection unit, a speech recognition unit, and a natural language processing unit, wherein the metadata collection unit collects metadata such as participant information of conversations held in the nursing care facility, start times of conversations, durations of conversations, and locations of conversations in real time, the speech recognition unit converts speech data of the conversations into text in real time, performs noise removal and speech clarification to realize accurate text conversion, and the natural language processing unit analyzes the conversation content converted into text, performs keyword extraction and emotion analysis, and grasps an emotional state and a health state of a resident.

The system, wherein the speech recognition unit prevents misrecognition and realizes accurate text conversion by using a customized dictionary even when words related to technical terms or specific care used in the nursing care facility are included.

The system, wherein the natural language processing unit, in addition to keyword extraction and emotion analysis, can use context analysis to understand the background and situation in which a resident is speaking and obtain deeper insights in order to grasp the resident's emotional state and health state.

A system for analyzing call data, comprising circuitry configured to: collect metadata of a call; convert speech data of the call into text in real time; analyze the call content converted into text; store analysis results in a database; visualize the analysis results; and perform prediction or suggestion regarding the call content based on the analysis results using AI technology.

The system, wherein the circuitry is configured to: collect the metadata including at least one of caller information, recipient information, a call start time, and a call identifier in real time; and store the collected metadata in a format compliant with applicable laws and regulations.

The system, wherein the circuitry is configured to: perform preprocessing including noise removal and speech clarification on the speech data of the call; and perform processing including keyword extraction, sentiment analysis, and topic modeling to identify at least one of a subject of the call, a customer's emotion, and a trend of topics.

A method for analyzing call data, comprising: collecting metadata of a call; converting speech data of the call into text in real time; analyzing the call content converted into text; storing analysis results in a database; visualizing the analysis results; and performing prediction or suggestion regarding the call content based on the analysis results using AI technology.

1. A system for analyzing call data,
comprising circuitry configured to:
collect metadata of a call;
convert speech data of the call into text in real time;
analyze call content converted into text;
store analysis results in a database;
visualize the analysis results; and
perform prediction or suggestion regarding the call content based on the analysis results using AI technology.

2. The system according to claim 1,
wherein the circuitry is configured to:
collect the metadata including at least one of caller information, recipient information, a call start time, and a call identifier in real time; and
store the collected metadata in a format compliant with applicable laws and regulations.

3. The system according to claim 1,
wherein the circuitry is configured to:
perform preprocessing including noise removal and speech clarification on the speech data of the call; and
perform processing including keyword extraction, sentiment analysis, and topic modeling to identify at least one of a subject of the call, a customer's emotion, and a trend of topics.

4. A method for analyzing call data, comprising:
collecting metadata of a call;
converting speech data of the call into text in real time;
analyzing call content converted into text;
storing analysis results in a database;
visualizing the analysis results; and
performing prediction or suggestion regarding the call content based on the analysis results using AI technology.
